(19) United States
(12) Patent Application Publication
(10) Pub. No.: US 2009/0169879 A1
(43) Pub. Date: Jul. 2, 2009

(54) CORROSION RESISTANT MULTI-LAYER WINDOW FILM CONSTRUCTION

(75) Inventor: Raghunath Padiyath, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/967,569

(22) Filed: Dec. 31, 2007

(51) Int. Cl. B32B 7/12

(52) U.S. Cl. 428/344

(57) ABSTRACT

A multi-layer transparent window film comprises a polymeric backing layer having opposed major surfaces, a layer of metal coated on at least one of the backing layer opposed major surfaces, and a layer of adhesive coated on the metal layer, wherein the adhesive comprises a corrosion inhibiting material.

### BACKGROUND

The present invention relates generally to window films, and more particularly to a multi-layer window film including a metal layer.

Metallized window films are known. U.S. Pat. No. 3,290,203, for example, discloses a flexible, transparent, metallized sheet material that is adhered to the inside surface of a windowpane. Metallized window films typically include a polymeric film, such as a polyester film, which is coated with copper, silver, gold, bronze, aluminum, stainless steel, nickel-chromium and other common metals or metal oxides. Such metal materials have a tendency to corrode in hostile environments, such as in coastal areas. To reduce corrosion, the edge of the window film may be sealed using a sealant, such as a silicone sealant, though this increases installation costs.

To reduce the corrosion of the exposed edge of the metal layer, the exposed edge of the metal layer may be treated with a corrosion inhibitor. U.S. Pat. No. 6,090,451 (Barth et al.), for example, discloses edge sealing a window film by moving a porous applicator tip saturated with liquid sealant in wiping contact along an edge of the window film to be sealed so as to transfer a portion of the liquid sealant from the saturated applicator tip to the window film edge.

U.S. Pat. No. 6,294,233 (Barth et. al.) discloses transparent edge sealed window films. The edges of the window film are preferably sealed by a liquid solvated polymer material which, upon curing, provides a solid transparent seal which significantly minimizes the degradative effects of the ambient environment.

U.S. Pat. No. 4,645,714 (Roche) discloses durable, specularly reflective mirrors for solar reflectors or fluorescent lamp fixtures that are formed by vapor-depositing silver on a polyester film and protectively covering it with a coating of transparent acrylate polymer containing a silver corrosion inhibitor such as glycol dimercaptoacetate.

### SUMMARY

The need exists for a corrosion resistant window film construction and, more particularly, for a simple, inexpensive, and effective method of imparting corrosion resistance to an exposed edge portion of a metal layer, such as silver, of a multi-layer window film.

The present invention generally provides a multi-layer, metallized, visually transparent, window film construction that is corrosion resistant. In one exemplary embodiment, the present invention provides a transparent window film comprising a polymeric backing layer having opposed major surfaces, a layer of metal coated on at least one of the backing layer opposed major surfaces, and a layer of adhesive coated on the metal layer, wherein the adhesive comprises a corrosion inhibiting material. In various embodiments, the metal layer may comprise, for example, aluminum, zinc, copper, silver, gold, and the like.

In another embodiment, the metal layer may be bounded on each side by layers of dielectric material. The layers of dielectric material may comprise metal oxide. In specific aspects, the dielectric layer may comprise indium tin oxide, titanium oxide, or zinc oxide.

In a specific embodiment, the corrosion inhibiting material may comprise glycol dimercaptoacetate (GDA).

In another exemplary embodiment, the present invention provides a transparent window film comprising a polymeric film having opposed first and second major surfaces, a layer of a mounting adhesive coated on the polymeric film first major surface for bonding the window film to a substrate, a first layer of a laminating adhesive including a corrosion inhibiting material arranged adjacent the polymeric film second major surface, and a metal layer arranged adjacent the second adhesive. In a more specific embodiment, the polymeric film may comprise first and second polyethylene terephthalate (PET) films adhesively bonded with a second layer of a laminating adhesive.

In one embodiment, the mounting adhesive may comprise a pressure sensitive adhesive, and the first layer of laminating adhesive may comprise a hot melt adhesive. In another embodiment, the metal layer may comprise a series of alternating layers of metal oxide and metal. The metal oxide may include indium oxide or indium tin oxide. In a specific embodiment, the metal may comprise silver.

In another aspect, the layer of laminating adhesive that includes the corrosion inhibiting material may comprise between about 0.01% and about 5% by weight corrosion inhibiting material. The corrosion inhibiting material may be selected from the group consisting of 1-octaddecane thiol (ODT), trimethylol propane tris(3-mercapto propionate) (TMP), 5-methyl-1H-benotriazole (MBT), pentaerythritol tetrakis(3-mercapto propionate) (PTT) and glycol dimercaptoacetate (GDA).

In another aspect, the present invention provides a window film assembly including a transparent metallized window film, as described above, applied to a window.

A window film having a metal layer that is highly conductive is desirable where the window film is to be used to prevent leakage of high frequency (e.g. 100 MHz-6 GHz) communication signals from the structure. In order to achieve a window film having the best combination of conductivity, transmission and reflection properties, it is desirable to use pure silver for the metal layer.

Silver layers, in particular, are highly prone to corrosion in the presence of atmospheric elements such as water and chlorine, especially along the exposed edges of the window film. That is, even though the layer of silver in a window film construction may be protected by a coating or a laminated film, the silver layer will be exposed to the corrosive elements of the surrounding environment along its edge. The corrosion process is accelerated with increased ambient temperature in the presence of, for example, salt and moisture. Corrosion is aesthetically undesirable and also interferes with the performance characteristics of the window film. To protect the silver layer from corrosion, the silver layer is often alloyed or sandwiched between layers of other metals, such as copper or gold. These corrosion protection methods, however, add cost to the window film, alter the appearance and optical transmission of the window film, and decrease the conductivity of the metal layer.

In many instances, a window film having low reflection in the visible part of the solar spectrum (400-800 nm) is desirable while maintaining a high degree of reflection in the near IR range (800 nm-2500 nm). Multi-layer window film constructions having a dielectric/metal/dielectric layer in an A/B/A/B . . . type sequence may be made by tailoring the thickness of the individual layers such that the reflection in the visible range is suppressed. Such films are described in, for example, U.S. Pat. No. 6,007,901 (Maschwitz, et al.) and U.S. Pat. No. 6,391,400 (Russell, et al.).

The present invention provides a window film construction in which a corrosion inhibitor is an integral part of the window film construction, rather than a topical or surface treatment applied to the window film. That is, the present invention eliminates the need to treat the window film to achieve corrosion resistance. Consequently, the use of the corrosion inhibitor does not require additional processing or installation steps, thereby simplifying installation and reducing labor costs. In addition, by incorporating the corrosion resistant material into the structure of the window film, more complete and effective protection against corrosion is achieved. That is, the present invention provides a window film construction in which the entire metal layer, and not just the edge of the metal layer, is corrosion resistant.

An advantage of the present invention is that it provides a window film having a metal layer—which would otherwise be prone to corrosion—with corrosion resistance. Other advantages include that it provides a quick, easy, and cost effective way of improving the corrosion resistance of an exposed edge of a metal layer in a multi-layer metallized window film construction. Another advantage of the present invention is that it provides improved corrosion resistance for silver layers, which improves the lifetime and performance of window films containing silver layers. Yet another advantage is that in many end use applications, the improved corrosion resistance may eliminate the need for edge sealing of the window film, a task which is difficult, messy and time consuming.

### BRIEF DESCRIPTION OF THE DRAWINGS

The present invention will be further described with reference to the accompanying drawings, in which:

FIG. 1 is an enlarged cross sectional view of a simple form of a window film according to the invention; and

FIG. 2 is an enlarged cross sectional view of an alternate embodiment of the invention.

### DETAILED DESCRIPTION

As used in this specification and the appended claims, the term “polymer” or “polymeric” will be understood to include polymers, copolymers (e.g., polymers formed using two or more different monomers), oligomers and combinations thereof, as well as polymers, oligomers, or copolymers that can be formed in a miscible blend.

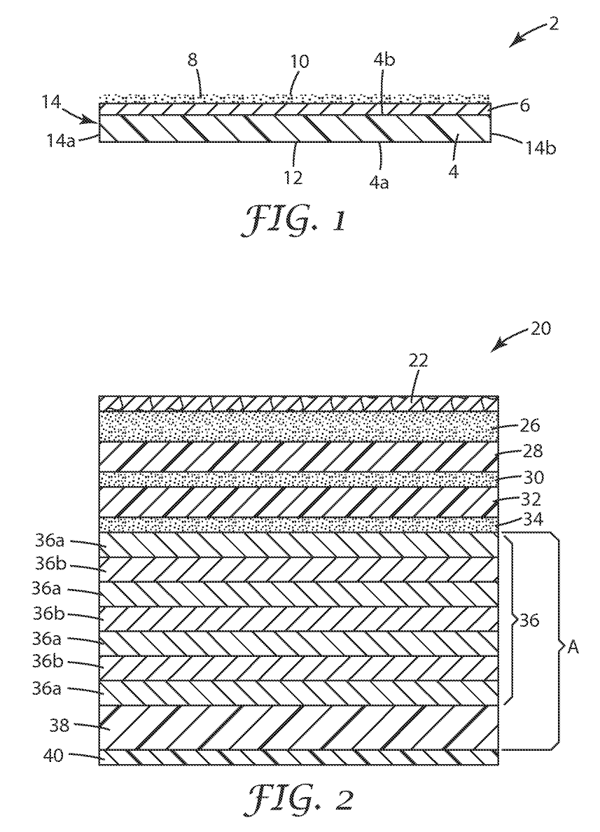

Referring now to the drawings, FIG. 1 shows a multi-layer window film composite 2 for selectively filtering the passage of electromagnetic waves through a window. The window film 2 includes a polymeric backing layer 4 having opposed major surfaces 4a, 4b, a metal layer 6 arranged adjacent one major surface 4b of the backing layer 4, and a layer of adhesive 8 arranged adjacent the metal layer opposite the backing layer 4.

The backing layer 4 may be any transparent polymer film commonly used for solar control or security films including, for example, a multi-layer film, and films formed of biaxially oriented polypropylene or polyethylene terephthalate (PET). A particularly suitable backing layer is a two (2) mil layer of polyethylene terephthalate (PET). Other suitable films include polyvinyl butyral (PVB) films, and the films described in U.S. Pat. No. 5,427,842 (Bland et al.) and U.S. Pat. No. 5,604,019 (Bland et al.), which are incorporated herein by reference. Suitable films for the backing layer 4 are available from 3M Company, St. Paul, Minn. under the trade designations SCLL400 film and 2 mil SCLL150 film.

The metal layer 6 may be formed of common metals such as silver, gold, copper, bronze, zinc, aluminum, stainless steel, nickel, chromium, and the like, metal oxides, and combinations of such materials. In one exemplary embodiment, the metal layer 6 is formed of silver. In another embodiment, the metal layer 6 may be sandwiched between a dielectric material. That is, the metal layer 6 may be bounded on each side by layers of dielectric material, thereby forming a dielectric/metal/dielectric layer in an A/BA/B . . . type sequence. The layers of dielectric material may comprise, for example, metal oxides such as indium tin oxide, titanium oxide, and zinc oxide.

The adhesive layer 8 is arranged adjacent the metal layer 6, such that the metal layer 6 is sandwiched between the backing layer 4 and the adhesive layer 8. The adhesive layer 8 may be, for example, any of those commonly used to affix solar control or security films to a substrate, such as a pane of window glass, including acrylate pressure-sensitive adhesives and water activated adhesives.

The window film 2 includes opposed first 10 and second 12 major surfaces, and a peripheral edge surface 14. The peripheral edge surface includes left 14a and right 14b sides edges as well as front and rear edges (not shown). Because the metal layer 6 is exposed to atmospheric conditions along the peripheral edge surface 14 of the window film 2, it is along the edge 14 that the window film 2 is most likely to experience corrosion.

In accordance with one aspect of the invention, it has been discovered that the degree of corrosion along the edge 14 of the window film 2, in which the metal layer 6 is exposed to ambient conditions, can be suppressed or reduced by incorporating a corrosion inhibiting material, such as a thiol (often referred to as mercaptan), into the adhesive layer 8. Accordingly, the invention generally involves integrating a corrosion inhibiting material into the window film construction.

Suitable corrosion inhibiting materials include mercaptoacetic acid, 3-mercaptopropionic acid, 11-mercaptoundecylic acid, thiophenol, diphenyl disulfide, N-(2-hydroxyethyl)mercaptoacetamide, 2,2′-dimercaptodiethyl ether, 2,2′-dimercapto diethyl thioether, 1,2-ethanedithiol, and 3-mercaptopropyl trimethoxysilane, glycol bis(3-mercaptopropionate), trimethylolpropane tris(3-mercaptopropionate), octadecyl mercaptan, dicetyl disulfide, octadecyl thioglycolate, 1-octaddecane thiol (ODT), trimethylol propane tris(3-mercapto propionate) (TMP), 5-methyl-1H-benotriazole (MBT), pentaerythritol tetrakis(3-mercapto propionate) (PTT) and glycol dimercaptoacetate (GDA).

Depending on the particular corrosion inhibiting material used, the concentration of the corrosion inhibiting material in the adhesive layer 8 may range from at least about 0.001%, at least about 0.01%, or at least about 0.05% by weight of dry solids of corrosion inhibiting material, to no greater than about 7%, no greater than about 6%, and no greater than about 5% by weight of dry solids of corrosion inhibiting material. Surprisingly, corrosion inhibitor levels as low as 0.05% by weight of dry solids have been found to effectively reduce corrosion. It has also been found that increasing the quantity of corrosion inhibiting material in the adhesive beyond a certain level can impact the adhesive properties of the adhesive. Thus, the desired quantity of corrosion inhibiting material present in the adhesive is that amount sufficient to achieve the desired level of corrosion resistance and also maintain the desired properties of the adhesive. That is, the quantity of corrosion inhibitor present in the adhesive will be the amount needed to achieve the desired level of corrosion resistance for the metal layer without compromising the desired properties of the adhesive.

Referring now to FIG. 2, there is shown an alternate metallized window film 20 having an adhesive layer including a corrosion inhibitor that serves to impart corrosion resistance to the metal layer, and particularly, to the edge of the metal layer.

The window film 20 includes a release liner 22 arranged over a layer of mounting pressure-sensitive adhesive (PSA) 26 that serves to adhesively bond the window film 20 to a substrate surface, such as a pane of window glass. The liner 22 may be, for example, a layer of one mil polyethylene terephthalate (PET). The liner 22 is provided to protect the PSA layer 26 during storage and handling of the window film 20 prior to applying the window film 20 to a surface, and is removed prior to installation to expose the PSA layer 26.

Adjacent the layer of mounting adhesive 26 is a first polymeric film layer 28, a first layer of laminating adhesive 30, a second polymeric film layer 32, and a second layer of laminating adhesive 34, respectively.

The first and second polymeric film layers 28, 32 may be, for example, tear resistant films. The first and second polymeric film layers 28, 32 may be the same or different films. Suitable films include polyvinyl butyral (PVB) films, and the films described in U.S. Pat. No. 5,427,842 (Bland et al.) and U.S. Pat. No. 5,604,019 (Bland et al.), which are incorporated herein by reference. Particular films suitable for the first and second tear resistant polymeric film layers 28, 32 are SCLL400 film and 2 mil SCLL150 film, respectively, available from 3M Company, St. Paul, Minn.

Suitable laminating adhesives include hot melt adhesives and acrylic PSAs. A suitable hot melt adhesive is amorphous polyethylene terephthalate (PET) sold under the trade designation VITEL polyester hot melt adhesive by Shell Chemical Company in Akron, Ohio. A suitable acrylic PSA comprises iso octyl acrylate and acrylamide. Specific acrylic PSAs include those available from 3M Company, St. Paul, Minn. under the trade designations 90/10 IOA/AA or 95/5 IOA/acrylamide acrylic PSAs. In accordance with one aspect of the window film, the second layer of laminating adhesive 34 includes a corrosion inhibiting material as described above with respect to adhesive layer 8.

Adjacent the second layer of laminating adhesive 34 is a metal layer 36 comprising a series of alternating layers of indium(III) oxide (InO) 36a and silver (Ag) 36b. Indium tin oxide (ITO) may be used in place of the InO. Adjacent the metal layer 36 is a polymeric backing layer 38. The backing layer 38 may be, for example, a two (2) mil layer of polyethylene terephthalate (PET). The combination of the metal layer 36 and the backing layer 38, which are designated by the letter “A” in FIG. 2, define a filtering film for attenuating electromagnetic waves in the frequency range from 100 MHz to 6 GHz and 120 GHz to 40 THz. Suitable films are described in, for example, U.S. Pat. No. 4,613,530 (Hood et al.) and U.S. Pat. No. 4,799,745 (Meyer et al.), which are incorporated herein by reference. Suitable films include the EMI/RFI shielding films available from Southwall Technologies, Palo Alto, Calif. A particular film suitable for the filtering film “A” is XEM2.4 film available from Southwall Technologies.

An optional hard coat 40 is provided on the backing layer 38 to provide the window film 20 with improved durability and scratch resistance. Suitable materials for the hardcoat include acrylic hardcoats such as Acryloid A-11 and Paraloid K-120N, available from Rohm & Haas, Philadelphia, Pa.; urethane acrylates, such as those described in U.S. Pat. No. 4,249,011 and those available from Sartomer Corp., Westchester, Pa.; and urethane hardcoats obtained from the reaction of an aliphatic polyisocyanate (e.g., Desmodur N-3300, available from Miles, Inc., Pittsburgh, Pa.) with a polyester (e.g., Tone Polyol 0305, available from Union Carbide, Houston, Tex.).

The layer of mounting adhesive 26, as well as the layers of laminating adhesive 30, 34, may be selected from conventional adhesives known to those skilled in the art except that a corrosion inhibiting material is incorporated into the layer of laminating adhesive 34 adjacent the metal layer 36, thereby to impart corrosion resistance to the metal layer 36. The adhesive layers may also include additives such as UV absorbers or other optional ingredients.

Persons of ordinary skill in the art may appreciate that various changes and modifications may be made to the invention described above without deviating from the inventive concept. Thus, the scope of the present invention should not be limited to the structures described in this application, but only by the structures described by the language of the claims and the equivalents of those structures.

What is claimed is:

1. A transparent window film, comprising:
(a) a polymeric backing layer having opposed major surfaces;
(b) a layer of metal coated on at least one of the backing layer opposed major surfaces; and
(c) a layer of adhesive coated on the metal layer, wherein the adhesive comprises a corrosion inhibiting material.

2. A window film as defined in claim 1, wherein the layer of adhesive comprises between about 0.01% and about 5% by weight corrosion inhibiting material.

3. A window film as defined in claim 1, wherein the metal layer consists essentially of silver.

4. A window film as defined in claim 1, wherein the metal layer comprises at least one of aluminum, zinc, copper, silver, and gold.

5. A window film as defined in claim 4, wherein the metal layer is bounded on each side by layers of dielectric material.

6. A window film as defined in claim 5, wherein the layers of dielectric material comprise metal oxide.

7. A window film as defined in claim 6, wherein the dielectric layer comprises at least one of indium tin oxide, titanium oxide, and zinc oxide.

8. A window film as defined in claim 1, wherein the corrosion inhibiting material is glycol dimercaptoacetate (GDA).

9. A transparent window film, comprising:
(a) a polymeric film having opposed first and second major surfaces;
(b) a layer of a mounting adhesive coated on the polymeric film first major surface for bonding the window film to a substrate;
(c) a first layer of a laminating adhesive including a corrosion inhibiting material arranged adjacent the polymeric film second major surface; and
(d) a metal layer arranged adjacent the second adhesive.

10. A window film as defined in claim 9, wherein the polymeric film comprises first and second polyethylene terephthalate (PET) films adhesively bonded with a second layer of a laminating adhesive.

11. A window film as defined in claim 10, wherein the mounting adhesive comprises a pressure sensitive adhesive.

12. A window film as defined in claim 11, wherein the first layer of laminating adhesive comprises a hot melt adhesive.

13. A window film as defined in claim 12, wherein the metal layer comprises a series of alternating layers of metal oxide and metal.

14. A window film as defined in claim 13, wherein the metal oxide is at least one of indium oxide and indium tin oxide.

15. A window film as defined in claim 14, wherein the metal comprises silver.

16. A window film as defined in claim 15, wherein the first layer of laminating adhesive comprises between about 0.01% and about 5% by weight corrosion inhibiting material.

17. A window film as defined in claim 16, wherein the corrosion inhibiting material is selected from the group consisting of 1-octaddecane thiol (ODT), trimethylol propane tris(3-mercapto propionate) (TMP), 5-methyl-1H-benotriazole (MBT), pentaerythritol tetrakis(3-mercapto propionate) (PTT) and glycol dimercaptoacetate (GDA).

18. A window assembly, comprising:
(a) a window frame;
(b) glazing having opposed major surfaces arranged within the window frame;
(c) window film as defined in claim 9 arranged adjacent at least one of the glazing opposed major surfaces.
